(19) United States
(12) Patent Application Publication
(10) Pub. No.: US 2006/0240253 A1
(43) Pub. Date: Oct. 26, 2006

(54) Guidewire and tube with lubricious coating

(75) Inventors: Vincent P. Bavaro, Temecula, CA (US); Jason R. Phillips, Wildomar, CA (US); Emmanuel C. Biagtan, Temecula, CA (US)

Correspondence Address: GUIDANT PATENT DOCKETING;FAEGRE & BENSON, LLP, 2200 WELLS FARGO CENTER, 90 SOUTH SEVENTH STREET, MINNEAPOLIS, MN, 55402-3901, US

(73) Assignee: Cardiac Pacemakers, Inc., St. Paul, MN (US)

(21) Appl. No.: 11/112,649

(22) Filed: Apr. 22, 2005

(51) Int. Cl. B32B 1/08

(52) U.S. Cl. 428/375; 428/36.91

(57) ABSTRACT

A hydrophilic polymer blend where at least one of the polymer materials is a water insoluble polymer and one of the materials is a hydrophilic water-soluble polymer. The invention includes a method of forming the hydrophilic polymer blend by melt mixing the hydrophilic polymer and the insoluble polymer into a finely dispersed polymer blend, forming strands of the hydrophilic polymer blend, and then pelletizing the strands.

### FIELD OF THE INVENTION

The present invention relates to hydrophilic polymers. More particularly, the present invention relates to a hydrophilic lubricous polymer blend that can form a hydrogel when cross-linked and placed into an aqueous environment and a method of making the same.

### BACKGROUND OF THE INVENTION

Water-sensitive hydrophilic polymers are commonly used in the manufacture of various personal care and medical devices. The water-sensitive polymers function to provide lubricity to the device when it becomes wetted with an aqueous solution such as water or a body fluid. The water-sensitive polymers may be used in conjunction with water-insoluble polymers that function to provide the appropriate structural characteristics and mechanical integrity to the device for its intended use. Typical medical devices that can benefit from lubricious properties include, for example, catheters, guide wires, endotracheal tubes and implants.

Patents have reported coating medical devices with water-soluble polymers that are hydrophilic. Such hydrophilic coatings have also been referred to as lubricous or “slippery” coatings. Typically, the hydrophilic polymer is dissolved in a suitable solvent and then applied to the desired medical device. The solvent is then evaporated to yield the coating. Oven drying may be utilized to remove the solvents. When the hydrophilic material is coated on the surface utilizing solvents in a wet method the polymer is usually formed as a fairly thin layer. The hydrophilic coating may break down or be removed upon prolonged turbulent flow, mechanical abrasion or soaking. Other drawbacks to the solution coating and curing process approach may include solution pot life, coating thickness control, and durability. See, for example, U.S. Pat. Nos. 4,119,094, 5,077,352 and 5,091,205, and EP Patent Nos. 0 106 004 B1 and 0 166 998 B1.

U.S. Pat. No. 5,061,424 discloses a method for preparing a shaped medical device provided with a lubricous coating. A coating composition comprising a blend of polyurethane and polyvinylpyrrolidone and polyethylene glycol is co-extruded with a substrate polymer to give a shaped medical device having a layer of the coating composition that then becomes lubricous when contacted with water.

U.S. Pat. No. 5,041,100 discloses a method for coating a substrate with a solution of polyethylene oxide and polyurethane. The polyethylene oxide is mixed with the polyurethane. The blend is then formed into a solution and then applied to medical device and dried to form a coating.

U.S. Pat. Nos. 5,113,585 and 5,454,164 report polymer blends for utilization in shaving systems. The polymer blends taught in these patents are specifically designed to abrade off with use in order to provide for skin lubrication.

Accordingly, there is a need in the art for improved lubricious polymer materials for incorporation into medical devices.

### BRIEF SUMMARY OF THE INVENTION

The present invention includes a blend of two or more polymer materials including a water insoluble polymer and a hydrophilic water-soluble polymer, the polymer blend is a finely dispersed blend that provides a lubricious surface.

One embodiment of the present invention includes a guidewire with a lubricous coating that includes a blend of a polyethylene oxide with a molecular weight between about 200,000 and about 7,000,000 and a polyether block amide, the blend including up to 60% by weight of the polyethylene oxide, the blend being substantially finely dispersed and forming a lubricious surface when exposed to an aqueous solvent.

Another embodiment of the present invention is a lubricious guidewire including a lubricious layer, the lubricious layer including a finely dispersed blend of a polyethylene oxide with a molecular weight of approximately 1,000,000 and a polyether block amide, the blend including about 40% by weight of the polyethylene oxide, the lubricious layer forming a lubricious surface when exposed to an aqueous solution.

Another embodiment includes a tube with at least one lubricious surface with a first inner layer formed of a substantially uniform polymer blend of a polyethylene oxide with a molecular weight of between about 200,000 and 7,000,000 and a polyether block amide, the blend including up to 60% by weight of the polyethylene oxide, the inner layer forming a lubricious inner surface when exposed to an aqueous solution and a second outer layer formed of a substantially water insoluble polymer.

Another embodiment of the present invention includes a method of forming a medical device with a lubricious surface including the steps of preparing a finely dispersed and substantially uniform polymer blend of polyethylene oxide, the polyethylene oxide molecular weight between about 200,000 and about 7,000,000, and a polyether block amide, the blend including up to 60% by weight of the polyethylene oxide and forming a medical device with the polymer blend, the medical device including at least one surface formed from the polymer blend.

Yet another embodiment is a multilayer tube with at least one lubricious surface including a lubricious layer including a finely dispersed blend of a polyethylene oxide of approximately 1,000,000 molecular weight and a polyether block amide, the blend including about 40% by weight of the polyethylene oxide, the lubricious layer being between about 0.001 and about 0.0025 inches thick and forming a lubricious inner surface when exposed to an aqueous solution, a substantially insoluble structural layer integrally formed with the lubricious layer wherein the structural layer constrains the lubricious layer from swelling more than about 5% in diameter upon contact with an aqueous solution at 37° C., and a third layer of a bonding material, the bonding material for securing the inner layer to the outer layer.

Another aspect of the present invention is a tube with a lubricious inner surface that includes an inner layer including a finely dispersed blend of a polyethylene oxide with a molecular weight of approximately 1,000,000 and a polyurethane, the blend including about 40% by weight of the polyethylene oxide, the inner layer being between about 0.001 and about 0.0025 inches thick and forming a lubricious inner surface when exposed to an aqueous solution and a substantially insoluble outer layer integrally formed with the inner layer wherein the outer polymer layer constrains the inner hydrophilic layer from swelling more than 5% in diameter upon contact with an aqueous solution at 37° C.

While multiple embodiments are disclosed, still other embodiments of the present invention will become apparent to those skilled in the art from the following detailed description, which shows and describes illustrative embodiments of the invention. The present invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 illustrates a scanning electron microscope digital image of a polymer blend of the present invention.

FIG. 2 illustrates a scanning electron microscope digital image a prior art polymer blend.

FIG. 3A illustrates a two-layer tube made with the present invention polymer blend.

FIG. 3B illustrates another two-layer tube made with the present invention polymer blend.

FIG. 4 illustrates the swell characteristics of a tube made with the present invention polymer blend.

FIG. 5A illustrates three-layer tube made with the present invention polymer blend.

FIG. 5B illustrates another three-layer tube made with the present invention polymer blend.

FIG. 5C illustrates yet another three-layer tube made with the present invention polymer blend.

FIG. 6 illustrates a comparison of the frictional force of two embodiments of the present invention against silicone versus prior art lubricious coatings.

FIG. 7 illustrates a comparison of the frictional force of two embodiments of the present invention against polyurethane versus prior art lubricious coatings.

FIG. 8 illustrates the swell rate of a tube made with an alternative embodiment polymer blend of the present invention.

### DETAILED DESCRIPTION OF THE INVENTION

The present invention is a formulation for and method of making a lubricious hydrophilic polymer blend and medical devices incorporating the same. The lubricious hydrophilic polymer blend may be referred to as a “polyblend,” a “hydrophilic polyblend,” or a “lubricious polymer.” In addition, the polyblend may be referred to as a hydrogel after cross-linking and exposure to a suitable aqueous solvent. A hydrogel is a colloidal gel in which the particles are dispersed in an aqueous solvent but only loses little or none of its structure to the solution.

The lubricious hydrophilic polyblend includes a lubricious water soluble polymer and an insoluble polymer. The two polymers are melt mixed and solidified to form a finely dispersed polyblend. The present invention polyblend can be utilized to provide a lubricious coating on a medical device formed by extruding, co-extruding, injection molding, or die forming, or, in further embodiments, the polyblend can be directly coated on a medical device. Embodiments of the coating formed using the lubricious hydrophilic polyblend of the present invention may be more robust and allow for superior permanence compared to previously taught lubricious coatings. As may be appreciated, the lubricious hydrophilic polyblend may be formed with or on any type of underlying structural article or framework to impart the desired lubricious properties to the final product.

Medical devices such as guidewires, catheters, sheaths, tubes, etc. that incorporate the present invention polyblend may help to reduce damage to the body during insertion because the lubricious surface will exert reduced frictional forces. Such medical devices may also help to reduce blood clotting as well. The materials of the present invention, therefore, help to prevent the devices from locking up or sticking during delivery procedures. In addition, the lubricious polyblend is not released or abraded away during use because the lubricious polymer is captured in the structural (or matrix) polymer.

The selection of the lubricious water-soluble polymer may depend on a number of factors. The lubricious polymer is partially miscible in the structural polymer but not completely miscible. When the lubricious polymer is only partially miscible rather than completely miscible the final lubricious hydrophilic polyblend will retain pockets of lubricious material dispersed throughout the polyblend. The lubricious polymer may also have a lower melting point and therefore a lower viscosity at a given temperature than the structural polymer. The lower viscosity lubricious polymer is more likely to migrate towards the outer surface of the polyblend. A lubricious hydrophilic material may be able to absorb many times its own weight in water.

In addition, the molecular weight may affect the lubricity of the final compound and so may be a factor in polymer selection. Extrusion grade resins may be of a higher molecular weight and therefore have more melt strength and will have more easily processed melt flow properties.

A lubricious hydrophilic polymer includes polyethylene oxide (PEO). Other lubricious materials may also be incorporated, such as polypropylene oxide (PPO), polyethylvinylalcohol (EVOH), polyethylvinylacetate (EVA), polyvinylpyrolidone (PVP), and other water-soluble lubricious polymers known to those skilled in the art may also be incorporated.

Structural polymers may include polyamides, polyurethanes, polyesters, olefin derived copolymers, polyethylene, high-density polyethylene (HDPE), natural and synthetic rubbers, styrenics, thermoplastic elastomers, and other specialty polymers. Polyamides may include homopolymers and copolymers like Nylon® 12 and 11, Pebax®, and Vestamid® resins. Nylon® 11 and Nylon® 12 copolymers may range in shore hardness from about 80D to 25D. Pebax is a polyether block amide manufactured by Arkema, Philadelphia, Pa. and is available in a variety of durometers. Polyurethanes may include polyesterurethanes and polyetherurethanes, like Pellethane® or Texin. One structural polymer may include polyetherurethane with a shore hardness from about 75D to 90D. Polyesters may include polyethylene terephthalate, polybutylene terephthalate, and co-polyesters like Hytrel® and Arnitel®. Rubbers may include silicone or Santoprene®. Thermoplastic elastomers may include commercially available materials like Kraton®.

In certain embodiments the structural polymer may be cross-linked by a predetermined amount to control the hydration rates and the swell of the polyblend. In further embodiments stabilizers may be included in the hydrophilic polymer blend, such as, for example, Irganox B225 or 1098. The polymer blend may also be formulated to include other advantageous materials, such as stabilizers, drugs, mixing aids, flow aids, plasticizers, heat stabilizers, antimicrobial agents, etc. In further embodiments, other anti-oxidants or other types of additives may also be utilized.

One hydrophilic polyblend of the present invention may include about 30 to about 60% PEO by weight. The polyblend may furthermore contain 35-50%, 40-50% PEO, or, particularly, about 40% PEO. The PEO is preferably greater than 100,000 MW. The PEO may include a molecular weight of about 200,000 to about 7,000,000, more particularly about 500,000 to 2,000,000, or, more particularly, about 1,000,000. In still further embodiments, the polyblend may be diluted during the extrusion or other medical device forming process to form materials with a lower weight percent of the hydrophilic polymer.

### EXAMPLES

### Example 1

A PEO with a molecular weight of 7,000,000(Dow WSR 303) was selected as the hydrophilic polymer and Pebax 72D was selected for the structural polymer. The final hydrophilic polymer blend included PEO at 40% by weight.

| Step | Setting |
|---|---|
| Resin Drying Process | |
| Drying Temp | 170° F. (Pebax)/60° C. (PEO) |
| Drying Time | 4 hrs. |
| Feeder Parameters | |
| PEO (7 million MW) | 70 grams/minute |
| Pebax 72D | 93 grams/minute |
| Extruder Parameters | |
| Zone #1 | 320° F. |
| Zone #2 | 355° F. |
| Zone #3 | 375° F. |
| Zone #4 | 375° F. |
| Die Zone (#5) | 375° F. |
| Screw Speed | 200 rpm |
| Extruder Responses | |
| Drive Torque | 72% |
| Extruder Output | 22 lbs./hr |
| Die Pressure | 350 psi |
| Melt Temp. | 373° F. |
| Process Water Temps | |
| Roll Temp | 45° F. |
| Chiller Temp | 45° F. |
| Pelletizing Process | |
| Pelletizer Speed | 210 rpm |

The polyether block amide was first dried at 170° F. for four hours. The PEO was dried at 60° C. in a vacuum oven (<25 mbar) for four hours. The drying time in the present example and all of the examples below can be for about the listed time or longer. The polymer materials were then separately loaded into two feeders controlled by a feeder control for addition to the compounding extruder. The compounding extruder was a Werner and Pfliedere ZSK30 co-rotating twin screw extruder. The extruder was equipped with a low shear/low energy screw that included two mixing zones, one dispersive and one distributive, each with six elements. The aspect ratio of the selected screw was 30:1 length:diameter and included modular conveying and mixing elements.

The PEO feeder was set at 70 grams/minute and the Pebax feeder was set at 93 grams/minute. The mixing barrel included four heat zones. The various heat zones and the screw type and rate allowed the material to be mixed and homogenized before it was passed through the die. The temperature zones of the barrel ranged from 320 to 375° F. The extruder response had a drive torque of 72% and the extruder output was 22 pounds per hour. The die temperature was set at 375° F. and the die pressure response at 350 psi. The die temperature zone and pressure can be controlled to insure a desired strand viscosity. The extensional viscosity (i.e., melt strength) of the material when it passed through the die was adjusted so that the produced polyblend strand maintained its shape until it was properly cooled.

In the present embodiments a die with four holes of 0.180″ inch diameter was utilized to form the polyblend into four concurrent strands. The extruded polyblend strands were then drawn out and cooled on the chill roller. Each strand was drawn to 0.100″ before being pelletized. A cooled water/glycol solution (1:1) chilled each roller but in the present embodiment no water touched the hydrophilic polyblend during the cooling process. The chill rolls utilized were Davis Standard laboratory grade three-roll stack sheet extrusion rollers. The pelletizer was a Gala strand pelletizer.

Once the molten strands were solidified the polymer blend was chopped/cut into pellets by the pelletizer set at 210 rpm.

### Example 2

A PEO with a molecular weight of 7,000,000 was utilized as the hydrophilic polymer and Pebax 72D was selected as the structural polymer. The final hydrophilic polymer blend included PEO at 40% by weight.

| Step | Setting |
|---|---|
| Resin Drying Process | |
| Drying Temp | PEO - 50° C. with vacuum |
| | Pebax - 160° F. with |
| | desiccant forced air |
| Drying Time | 12 hrs |
| Feeder Parameters | |
| PEO (7 million MW) | 50 grams/minute |
| Pebax 72D | 75 grams/minute |
| Extruder Parameters | |
| Zone #1 | 320° F. |
| Zone #2 | 355° F. |
| Zone #3 | 370° F. |
| Zone #4 | 360° F. |
| Die Zone (#5) | 360° F. |
| Screw Speed | 152 rpm |
| Extruder Responses | |
| Drive Torque | 79% |
| Extruder Output | 16.5 lbs./hr |
| Die Pressure | 500 psi |
| Process Water Temps | |
| Roll Temp | 32° F. |
| Chiller Temp | 32° F. |
| Pelletizing Process | |
| Pelletizer Speed | 160 rpm |

### Example 3

The next example utilized a PEO with a molecular weight of 7,000,000 and Pebax 72D. The final hydrophilic polymer blend included PEO at 60% by weight

| Step | Setting |
|---|---|
| Resin Drying Process | |
| Drying Temp | PEO - 50° C. with vacuum |
| | Pebax - 160° F. with desiccant |
| | forced air |
| Drying Time | 24 hrs/24 hrs |
| Feeder Parameters | |
| PEO (7 million MW) | 75.0 grams/minute |
| Pebax 72D | 50.0 grams/minute |
| Extruder Parameters | |
| Zone #1 | 320° F. |
| Zone #2 | 355° F. |
| Zone #3 | 370° F. |
| Zone #4 | 360° F. |
| Die Zone (#5) | 360° F. |
| Screw Speed | 175 rpm |
| Extruder Responses | |
| Drive Torque | 81% |
| Extruder Output | 16.5 lbs./hr |
| Die Pressure | 680 psi |
| Process Water Temps | |
| Roll Temp | 32° F. |
| Chiller Temp | 32° F. |
| Pelletizing Process | |
| Pelletizer Speed | 130 rpm |

### Example 4

A PEO with a molecular weight of 1,000,000 (Dow WSRN 12) was utilized as the hydrophilic polymer and Pebax 72D was the structural polymer. The final hydrophilic polymer blend included PEO at 40% by weight.

| Step | Setting |
|---|---|
| Resin Drying Process | |
| Drying Temp | PEO - 50° C. with vacuum |
| | Pebax - 160° F. with |
| | desiccant forced air |
| Drying Time | 12 hrs |
| Feeder Parameters | |
| PEO (1,000,000 MW) | 50 grams/minute |
| Pebax 72D | 75 grams/minute |
| Extruder Parameters | |
| Zone #1 | 320° F. |
| Zone #2 | 355° F. |
| Zone #3 | 370° F. |
| Zone #4 | 360° F. |
| Die Zone (#5) | 360° F. |
| Screw Speed | 175 rpm |
| Extruder Responses | |
| Drive Torque | 65% |
| Extruder Output | 16.5 lbs./hr |
| Die Pressure | 420 psi |
| Process Water Temps | |
| Roll Temp | 32° F. |
| Chiller Temp | 32° F. |
| Pelletizing Process | |
| Pelletizer Speed | 120 rpm |

### Example 5

A PEO with a molecular weight of 200,000 (Dow WSRN80) was mixed with Pebax 72D. The final hydrophilic polymer blend included PEO at 40% by weight.

| Step | Setting |
|---|---|
| Resin Drying Process | |
| Drying Temp | PEO - 50° C. with vacuum |
| | Pebax - 160° F. with |
| | desiccant forced air) |
| Drying Time | 24 hrs/24 hrs |
| Feeder Parameters | |
| PEO (200,000 MW) | 50.0 grams/minute |
| Pebax 72D | 75.0 grams/minute |
| Extruder Parameters | |
| Zone #1 | 320° F. |
| Zone #2 | 355° F. |
| Zone #3 | 370° F. |
| Zone #4 | 360° F. |
| Die Zone (#5) | 360° F. |
| Screw Speed | 173 rpm |
| Extruder Responses | |
| Drive Torque | 58% |
| Extruder Output | 16.5 lbs./hr |
| Die Pressure | 250 psi |
| Melt Temp. | 352° F. |
| Process Water Temps | |
| Roll Temp | 32° F. |
| Chiller Temp | 33° F. |
| Pelletizing Process | |
| Pelletizer Speed | 125 rpm |

### Example 6

The hydrophilic polymer was a PEO with a molecular weight of 1,000,000 and the structural polymer was Pebax 72D. The final hydrophilic polymer blend included PEO at 40% by weight.

| Step | Setting |
|---|---|
| Resin Drying Process | |
| Drying Temp | PEO - 50° C. with vacuum |
| | Pebax - 160° F. with |
| | desiccant forced air |
| Drying Time | 36 hrs/24 hrs |
| Feeder Parameters | |
| PEO (1,000,000 MW) | 50.0 grams/minute |
| Pebax 72D | 75.0 grams/minute |
| Extruder Parameters | |
| Zone #1 | 320° F. |
| Zone #2 | 355° F. |
| Zone #3 | 370° F. |
| Zone #4 | 360° F. |
| Die Zone (#5) | 360° F. |
| Screw Speed | 170 rpm |
| Extruder Responses | |
| Drive Torque | 70% |
| Extruder Output | 16.5 lbs./hr |
| Die Pressure | 520 psi |
| Melt Temp. | 341° F. |
| Process Water Temps | |
| Roll Temp | 32° F. |
| Chiller Temp | 33° F. |
| Pelletizing Process | |
| Pelletizer Speed | 125 rpm |

### Example 7

A PEO of with a molecular weight of 7,000,000 was mixed with HDPE as the structural polymer. The HDPE was a Quantum HDPE 6007 (0.6 MFI) (Phillips Slurry process). The final hydrophilic polymer blend included PEO at 35% by weight. Only the PEO was dried as the HDPE is hydrophobic. The PEO was dried under a vacuum to approximately 0.03 weight percent water.

| Step | Setting |
|---|---|
| Resin Drying Process | |
| Drying Temp | Vacuum (PEO) |
| Drying Time | |
| Feeder Parameters | |
| PEO (7,000,000 MW) | 56 grams/minute |
| HDPE | 104 grams/minute |
| Extruder Parameters | |
| Zone #1 | 375° F. |
| Zone #2 | 430° F. |
| Zone #3 | 450° F. |
| Zone #4 | 450° F. |
| Die (#5) | 450° F. |
| Screw Speed | 134 rpm |
| Extruder Responses | |
| Die Pressure | 490 psi |
| Torque | 45% |
| Output | 20 lbs./hr |
| Melt Temp. | 456° F. |
| Process Water Temps | |
| Chiller Temp | 60° F. |
| Fluid Temp | 50° F. |
| Pelletizing Process | |
| Cutter Speed | 190 (rpm) |

### Example 8

A PEO with a molecular weight of 7,000,000 was mixed with Pebax 72D. The final hydrophilic polymer blend included PEO at 35% by weight. Both materials were dried under a vacuum to approximately 0.03 weight percent water.

| Step | Setting |
|---|---|
| Resin Drying Process | |
| Drying Temp | Vacuum |
| Drying Time | |
| Feeder Parameters | |
| PEO (7,000,000 MW) | 84 grams/minute |
| Pebax | 157 grams/minute |
| Extruder Parameters | |
| Zone #1 | 320° F. |
| Zone #2 | 335° F. |
| Zone #3 | 385° F. |
| Zone #4 | 360° F. |
| Die (#5) | 360° F. |
| Screw Speed | 175 rpm |
| Extruder Responses | |
| Die Pressure | 510 psi |
| Torque | 87% |
| Output | 30 lbs./hr |
| Melt Temp. | 360° F. |
| Process Water Temps | |
| Roll Temp | 50° F. |
| Chiller Temp | 74° F. |
| Pelletizing Process | |
| Cutter Speed | 290 (rpm) |

### Example 9

In the ninth example a PEO with a molecular weight of 7,000,000 was utilized as the hydrophilic polymer and HDPE was the structural polymer. The final hydrophilic polymer blend included PEO at 40% by weight. The PEO was dried under a vacuum to approximately 0.03 weight percent water. The produced strands were cooled by conventional means, which included running the strands through a water bath at approximately room temperature and then pelletized.

| Step | Setting |
|---|---|
| Resin Drying Process | |
| Drying Temp | Vacuum |
| Drying Time | |
| Feeder Parameters | |
| PEO (7,000,000 MW) | 7.4 grams/minute |
| HDPE | 4.8 grams/minute |
| Extruder Parameters | |
| Zone #1 | 375° F. |
| Zone #2 | 422° F. |
| Zone #3 | 431° F. |
| Zone #4 | 401° F. |
| Die (#5) | 400° F. |
| Screw Speed | 175 rpm |
| Extruder Responses | |
| Die Pressure | 530 psi |
| Torque (%) | 80% |
| Output (#/hr) | 12 lbs./hr |
| Water Bath Temp | Room Temp Bath |

### Example 10

A PEO with a molecular weight of 7,000,000 was utilized as the hydrophilic polymer and Pebax 72D was the structural polymer. The final hydrophilic polymer blend included PEO at 40% by weight. The produced strands were cooled by running on a conveyor belt cooled with an air conditioner and then pelletized.

| Step | Setting |
|---|---|
| Resin Drying Process | |
| Drying Temp | 200° for Pebax/Vacuum for PEO |
| Drying Time | 12 hrs/12 hrs |
| Feeder Parameters | |
| PEO | 6 grams/minute |
| Pebax | 4.0 grams/minute |
| Extruder Parameters | |
| Zone #1 | 350° F. |
| Zone #2 | 400° F. |
| Zone #3 | 400° F. |
| Zone #4 | 380° F. |
| Die (#5) | 380° F. |
| Conveyance Settings | |
| Screw Speed | 200 |
| Extruder Responses | |
| Die Pressure | 390 psi |
| Torque | 90% |
| Output | 9.99 lbs./hr |
| Belt Temp | AC cooling - forced air |

### Example 11

The hydrophilic polyblend was formed utilizing 20% by weight PEO, with a molecular weight of 7,000,000, with 80% by weight Pellethane 90A. The two polymers were first mixed together with about 2% by weight triallyl triazine trione (Aldrich Chemical Co., Milwaukee, Wis.) and about 0.2% by weight Irganox 1098. The materials were added to the extruder through one feeder.

| Step | Setting |
|---|---|
| Resin Drying Process | |
| Drying Temp | PEO - 78° F. with vacuum |
| | Pellethane 150° F. with forced |
| | air desiccant |
| Feeder Parameters | |
| All materials | 60 grams/minute |
| Extruder Parameters | |
| Zone #1 | 335° F. |
| Zone #2 | 355° F. |
| Zone #3 | 365° F. |
| Zone #4 | 365° F. |
| Die (#5) | 380° F. |
| Conveyance Setting | |
| Screw Speed | 94 rpm |
| Extruder Responses | |
| Die Pressure | 141 psi |
| Torque | 15.8% |
| Process Temps | Belt cooled with A/C |
| Pelletizing Process | |
| Cutter Speed | 167 (rpm) |

### Comparison Example

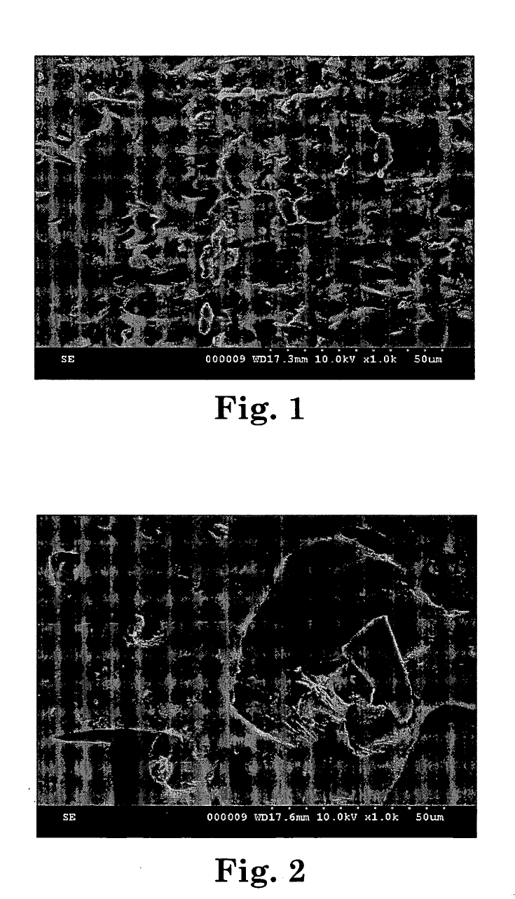

The miscibility characteristics of PEO in Pebax versus PVP in Pebax was compared. A polyblend of 40% PEO (WSRN12K, 1,000,000 MW)/60% Pebax 72D with 0.2 pphr (parts per hundred resin) Irganox B225 was formulated to compare with a polyblend of 40% PVP (K-90, 900,000-1,700,000 MW)/60% Pebax 72D with 0.2 pphr Irganox B225. After creation of each polyblend the material was extruded into a cylinder and cross-sectioned. The samples were placed in water at room temperature for 8 hours to dissolve the hydrophilic phase. Each sample was then dehydrated for eight hours in a vacuum oven and gold coated for viewing under a scanning electron microscope. FIG. 1 illustrates the SEM of the PEO polyblend. The PEO showed consistent and uniform dispersion in the structural material. As shown, the PEO and the Pebax form a finely dispersed blend that is substantially uniform. FIG. 2 illustrates the PVP polyblend. From the image of the PVP polyblend it is apparent that the PVP droplets are not of a uniform size, are larger, and are poorly dispersed. The PEO therefore creates a more finely dispersed polyblend material. Clumps of the PVP material were visible to the unaided eye. The PVP polyblend is therefore less miscible in the polyether block amide structural polymer and presents a less uniformly lubricious surface. In addition, large irregular deposits of PVP on the surface make the polyblend brittle and thus easier to break off during use and may be possibly released as a contaminant into the body.

Each of the co-extruded PEO and PVP polyblends were also tested for suitability in a medical device. The PVP polyblend displayed brittle characteristics and could only be elongated less than 5%. The brittleness of the compound rendered it unacceptable for medical device applications. Moreover, upon hydration in 37° C. water the co-extruded PVP became only moderately lubricious to the hand.

In comparison, the PEO polyblend rendered a tough compound with high strength. The PEO polyblend was tested and showed elongation values greater than 80%. The tough properties of the PEO polyblend also made it useful for medical device applications. Moreover, upon hydration in 37° C. water the PEO polyblend became very lubricious to the hand. PEO polyblends, therefore, are superior to PVP polyblends for medical device lubricating applications.

Medical Devices Formed from the Polyblend

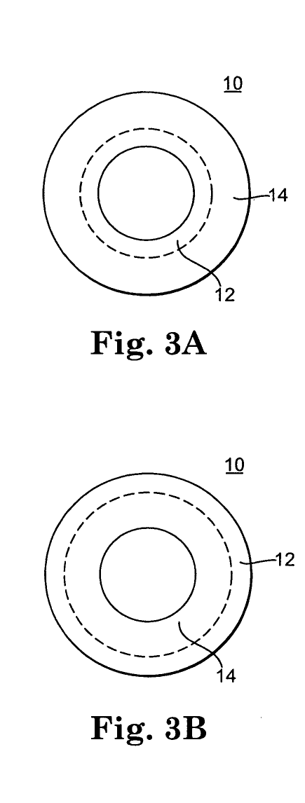

FIG. 3A illustrates a dual layer tube 10 with an inner layer 12 formed from the PEO polyblend and a polymer outer layer 14. The tube 10 may be formed by co-extrusion and the inner layer 12 may be between about 0.001-0.0025 inches thick. Furthermore, the tube 10 may be incorporated into any medical device, such as, for example, a catheter, a sheath, a stent or lead delivery device, an introducer, or a dilator. The tube 12 may further be made from any of the PEO polyblend materials previously discussed. As illustrated in FIG. 3B, the outer layer 14 may be the lubricious polyblend.

The inner layer 12 forms a lubricious surface when exposed to blood or other suitable polar liquids, such as water. The lubricious surface may reduce the drag friction experienced by a lead or stent when passed through the tube. In addition, the lubricious surface may reduce drag friction when incorporated as part of a telescoping dual catheter arrangement. In this telescoping embodiment, the lubricious layer may be included on the inside of the outer guide, the outside of the inner guide, or both.

In further embodiments, the inner layer 12 (or other medical device formed utilizing the lubricious polymer blend) may be electron beam cross-linked with, for example, a 10 kEV electron beam. Such an electron beam may be at a variety of strengths, such as at 5 or 10 Mrad, and may be applied once, twice, or more than twice. Utilizing such an electron beam is known in the art for sterilizing catheters and also for helping to secure the layers of the catheter together. Cross-linking the inner layer 12 improves the retention rate of the PEO when a stent or other device is passed through the lumen of the catheter. Such cross-linking may also improve the retention rate of the lubricious surface on the outside of the catheter. Cross-linking may furthermore reduce the swell rate.

The cross-linking of the PEO polyblend may form a cross-linked polymer matrix (an interpenetrating cross-linked network) that is water swellable. Such a material may form a hydrogel when hydrated. During hydration the hydrogel will not dissolve in the aqueous solution but will become water swollen and lubricious. Determining the right amount of cross-linking energy to expose the PEO polyblend to may be determined by minimizing the amount of free PEO that dissolves during hydration. This amount may be determined by the sol point or weight loss of the hydrogel after cross-linking, hydration, and drying. As may be appreciated, various structural polymer materials may be more or less susceptible to cross-linking in this manner. In addition, other agents may be added to the polyblend to improve the cross-linking and to affect the resultant structure.

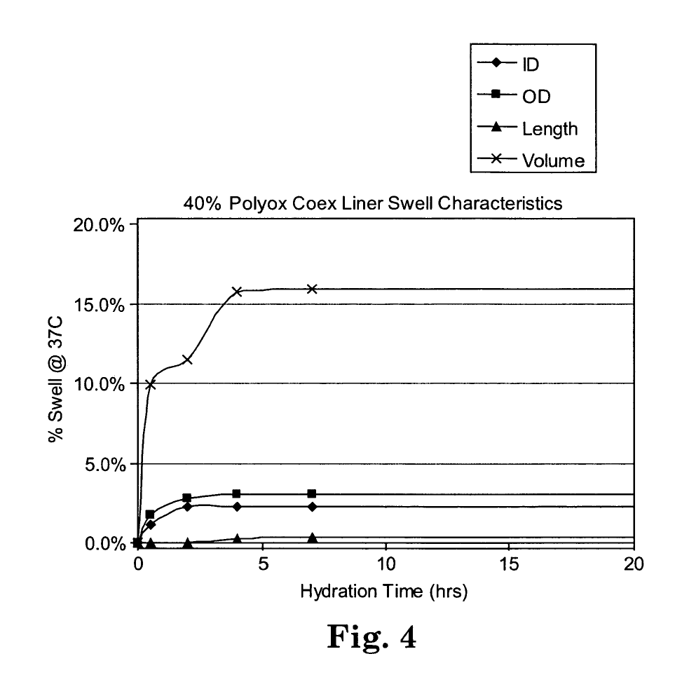

In one example, a two-layer catheter liner (tube) was formed by co-extrusion using the 40% PEO (1 million MW)/Pebax 72D polyblend as an inner layer with Nylon 12 as the outer layer. The PEO polyblend inner layer was approximately 0.002 inch thick. The swell characteristics of the liner was then determined by soaking in a water bath at 37° C. and measuring at certain time intervals. As can be seen from FIG. 4, and from the data reproduced below, after 94 hours the inner diameter of the liner had only changed about 2.2% and the outer diameter had only changed about 3.1%.

| Hydration | | Percent | | Percent | Average | Percent | Average | Percent |
|---|---|---|---|---|---|---|---|---|
| Time | Average | Change | Average | Change | Length | Change | Volume | Change |
| (hr) | ID (in) | (%) | OD (in) | (%) | (in) | (%) | (in³) | (%) |
| 0 | 0.090 | 0.0% | 0.098 | 0.0000 | 3.000 | 0.000 | 0.0035 | 0 |
| 0.5 | 0.091 | 1.1% | 0.100 | 1.7% | 3.000 | 0.0% | 0.0039 | 9.9% |
| 2 | 0.092 | 2.2% | 0.101 | 2.8% | 3.000 | 0.0% | 0.0040 | 11.5% |
| 4 | 0.092 | 2.2% | 0.101 | 3.1% | 3.007 | 0.2% | 0.0041 | 15.7% |
| 7 | 0.092 | 2.2% | 0.101 | 3.1% | 3.010 | 0.3% | 0.0041 | 15.9% |
| 94 | 0.092 | 2.2% | 0.101 | 3.1% | 3.010 | 0.3% | 0.0041 | 15.9% |

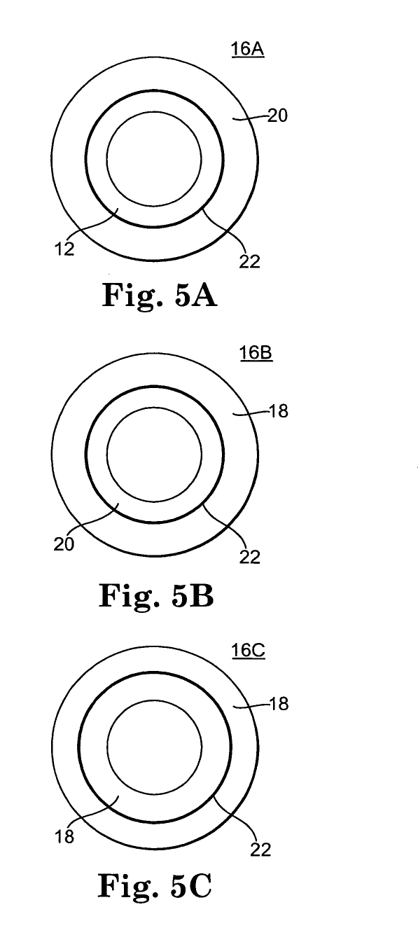

In still another embodiment illustrated in FIG. 5A, the hydrophilic polyblend may be part of a three-layer tube 16A. The lubricious polyblend may be the inner layer 18 and include another polymer as an outer layer 20. A third layer 22 formed of a third material may be disposed between the inner layer 18 and outer layer 20 to help secure them together. One such third layer 22 may include a graft maleic anhydride or an acrylic acid copolymer. In still further embodiments, as shown in FIG. 5B, the lubricious polyblend may be the outer layer 20 of a tube 16B. In yet another embodiment, as shown in FIG. 5C, both the inner layer 18 and out the outer layer 20 of a tube 16C are lubricious polyblends.

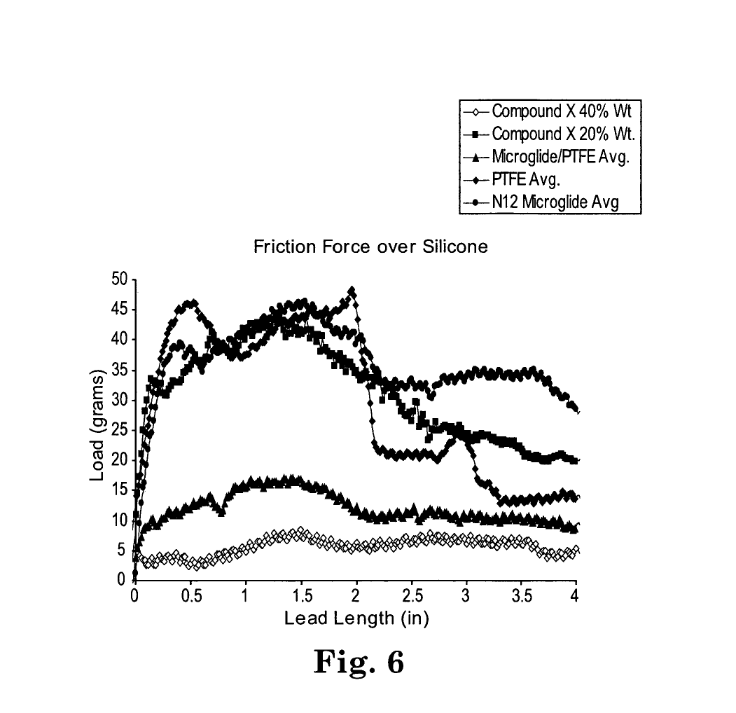

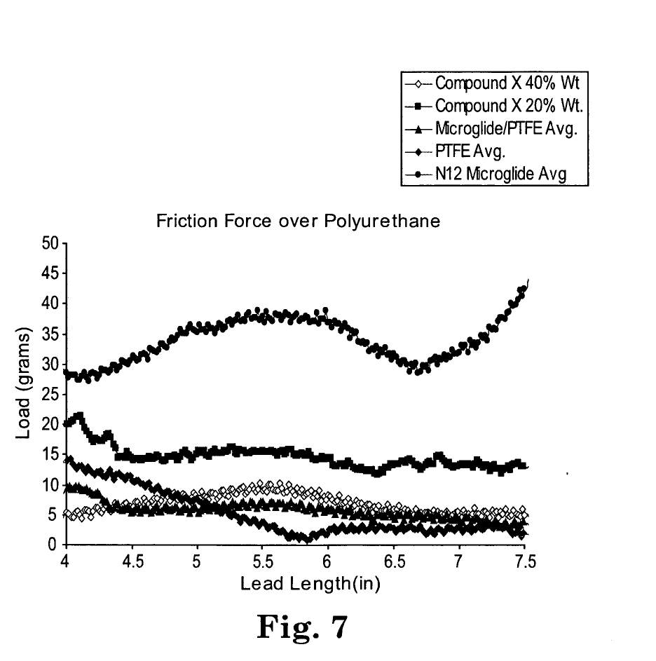

FIGS. 6-7 compare two formulations of the present invention against lubricious coatings known in the art. The polyblend was formulated to include 40% and 20% by weight PEO (1,000,000 MW) blended with Pebax 72D. The 40% PEO polyblend was made as shown in Example 1. The 20% PEO polyblend was created by diluting the 40% PEO during the extrusion process with more Pebax 72D. The testing was done by coating the interior of a catheter with the hydrophilic polyblend and using silicone and polyurethane coated leads attached to an Instron Universal Testing Machine (Canton, Pa.) to simulate the vascular anatomy and to measure the force necessary to pull the lead through the catheter.

As illustrated in FIG. 6, when the present invention polyblend is utilized to form a coating the frictional force over silicone is better than three previously known compounds. As illustrated in FIG. 7, the frictional force over polyurethane of the present invention is better than two of the three compounds and approximately the same as the third material.

As may be appreciated, in further embodiments the lubricious polyblend of the present invention may be utilized with any type of medical device known to those in the art that benefits from a lubricious layer.

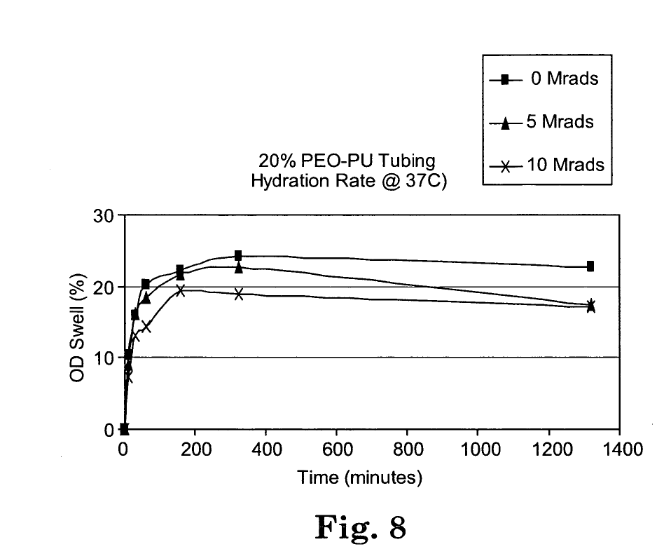

In another embodiment, a 20% PEO-PU polyblend (Pellethane® 90AE) material was formed. The material was then extruded to form a tube and cross-linked by exposure to an electron beam at 5 and 10 Mrads. As illustrated in FIG. 8, cross-linking the polyblend to form a matrix served to reduce the overall swelling of the tube when hydrated.

In further embodiments, the tubing formed from any of the previously described mixtures may be melted and utilized to directly coat a guidewire using a process such as is disclosed in U.S. Pat. No. 6,695,915, which is incorporated by reference for all that it teaches and discloses. Such a guidewire may be lubricous when exposed to blood during insertion and therefore be more easily inserted further into the vasculature. Moreover, the reduced swelling may aid in vasculature insertion. The lubricious hydrophilic polyblend may also be coated on the guidewire by other methods known to those in the art, such as dipping the guidewire directly into a melt pool of the hydrophilic polymer blend or by any other method known to those in the art. Various characteristics of the guidewire may make the polyblend may influence adhesion on to the guidewire. In further embodiments, pre-coatings or other pre-treatments may be applied to the guidewire before coating with the polyblend. Moreover, cross-linking the material coated on the guidewire may reduce swelling and improve retention of the lubricious material.

Other intravenous devices for which the present invention polyblend may impart desirable lubricious properties may include 1) a guiding catheter shaft using the hydrophilic compound as the inner layer; 2) a polymer shunt or stent delivery device where the hydrophilic compound is the inner layer and is impregnated with an anti-coagulant agent to prevent clotting, cholesterol or other blood component build up in the arteries; 3) an implantable device (lead) outer or inner layer; and 4) a lead electrode coating.

Various modifications and additions can be made to the exemplary embodiments discussed without departing from the scope of the present invention. Accordingly, the scope of the present invention is intended to embrace all such alternatives, modifications, and variations as fall within the scope of the claims, together with all equivalents thereof.

1. A guidewire with a lubricous coating comprising a blend of a polyethylene oxide with a molecular weight between about 200,000 and about 7,000,000 and a polyether block amide, the blend including up to 60% by weight of the polyethylene oxide, the blend being substantially finely dispersed and forming a lubricious surface when exposed to an aqueous solvent.

2. The guidewire of claim 1 wherein the blend includes between about 35% and about 50% polyethylene oxide.

3. The guidewire of claim 1 wherein the blend includes about 40% polyethylene oxide.

4. The guidewire of claim 1 wherein the polyethylene oxide has a molecular weight of about 1,000,000.

5. The guidewire of claim 1 wherein the blend includes a stabilizer.

6. The guidewire of claim 1 wherein the blend is cross-linked a predetermined amount.

7. The guidewire of claim 6 wherein the blend is electron beam cross-linked.

8. A lubricious guidewire comprising a guidewire with a lubricious layer, the lubricious layer including a finely dispersed blend of a polyethylene oxide with a molecular weight of approximately 1,000,000 and a polyether block amide, the blend including about 40% by weight of the polyethylene oxide, the lubricious layer forming a lubricious surface when exposed to an aqueous solution.

9. A tube with at least one lubricious surface comprising:
a first inner layer formed of a substantially uniform polymer blend of a polyethylene oxide with a molecular weight of between about 200,000 and 7,000,000 and a polyether block amide, the blend including up to 60% by weight of the polyethylene oxide, the inner layer forming a lubricious inner surface when exposed to an aqueous solution; and
a second outer layer formed of a substantially water insoluble polymer.

10. The tube of claim 9 further comprising the outer layer adhered around the inner layer.

11. The tube of claim 9 wherein the polymer blend includes between about 35% and about 50% polyethylene oxide.

12. The tube of claim 9 wherein the polymer blend includes about 40% polyethylene oxide.

13. The tube of claim 9 wherein the outer layer prevents the first inner layer from swelling more than about 5% in diameter upon contact with an aqueous solution at 37° C.

14. The tube of claim 9 further comprising a third layer disposed between the first inner layer and the second outer layer, the third layer bonding the first inner layer to the second outer layer.

15. The tube of claim 14 wherein the third layer is selected from the group consisting of a graft maleic anhydride and an acrylic acid copolymer.

16. The tube of claim 9 wherein the polyethylene oxide has a molecular weight of about 1,000,000.

17. The tube of claim 9 wherein the polyether block amide has a shore hardness of 72D.

18. The tube of claim 9 wherein the inner layer is between about 0.001 and 0.0025 inches thick.

19. The tube of claim 9 wherein the inner layer is cross-linked a desired amount.

20. A method of forming a medical device with a lubricious surface comprising:
preparing a finely dispersed and substantially uniform polymer blend of polyethylene oxide, the polyethylene oxide molecular weight between about 200,000 and about 7,000,000, and a polyether block amide, the blend including up to 60% by weight of the polyethylene oxide; and
forming a medical device with the polymer blend, the medical device including at least one surface formed from the polymer blend.

21. The method of claim 20 wherein the forming step further comprises one or more of co-extruding, molding, or die forming the polymer blend with a structural article.

22. The method of claim 21 wherein the structural article is formed from a polymer.

23. The method of claim 21 further comprising cross-linking the polymer blend a desired amount.

24. The method of claim 23 wherein the cross-linking is accomplished by exposing the blend to an electron beam.

25. A multilayer tube with at least one lubricious surface comprising:
a lubricious layer including a finely dispersed blend of a polyethylene oxide of approximately 1,000,000 molecular weight and a polyether block amide, the blend including about 40% by weight of the polyethylene oxide, the lubricious layer being between about 0.001 and about 0.0025 inches thick and forming a lubricious inner surface when exposed to an aqueous solution;
a substantially insoluble structural layer integrally formed with the lubricious layer wherein the structural layer constrains the lubricious layer from swelling more than about 5% in diameter upon contact with an aqueous solution at 37° C.; and
a third layer of a bonding material, the bonding material for securing the inner layer to the outer layer.

26. The multilayer tube of claim 25 wherein the structural layer is a polyamide.

27. A tube with a lubricious inner surface comprising:
an inner layer including a finely dispersed blend of a polyethylene oxide with a molecular weight of approximately 1,000,000 and a polyurethane, the blend including about 40% by weight of the polyethylene oxide, the inner layer being between about 0.001 and about 0.0025 inches thick and forming a lubricious inner surface when exposed to an aqueous solution; and
a substantially insoluble outer layer integrally formed with the inner layer wherein the outer polymer layer constrains the inner hydrophilic layer from swelling more than 5% in diameter upon contact with an aqueous solution at 37° C.
